(19) United States
(12) Patent Application Publication
(10) Pub. No.: US 2019/0158512 A1
(43) Pub. Date: May 23, 2019

(54) LIGHTWEIGHT ANTI-RANSOMWARE SYSTEM

(71) Applicant: Fortinet, Inc., Sunnyvale, CA (US)

(72) Inventor: Jie Zhang, Langley (CA)

(73) Assignee: Fortinet, Inc., Sunnyvale, CA (US)

(21) Appl. No.: 15/818,448

(22) Filed: Nov. 20, 2017

(51) Int. Cl. H04L 29/06

(52) U.S. Cl. CPC H04L 63/1416; H04L 63/145

(57) ABSTRACT

Systems and methods for detecting ransomware are provided. According to one embodiment, a computer device intercepts an operation on a file by an application and determines whether the application is ransomware based on one or more factors. The computer device mitigates the operation to the file when the application is deemed to be ransomware.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2017, Fortinet, Inc.

### BACKGROUND

### Field

Embodiments of the present invention generally relate to the field of network security techniques. In particular, various embodiments relate to a lightweight anti-ransomware system for detecting and mitigating ransomware on a client machine.

### Description of the Related Art

The first Ransomware (a type of malicious software from cryptovirology that threatens to publish the victim's data or perpetually block access to it unless a ransom is paid) was discovered in 2005. Since then, it has become a big issue in the antivirus (AV) area. Currently, there are three major kinds of Anti-Ransomware methods:

### 1. Pre-Prevention:

These kinds of tools attempt to use multiple static and/or dynamic detection approaches to stop known and unknown ransomware from running. Some of them attempt to recognize unknown Ransomware in its earlier running stage so as to prevent it from encrypting user files.

The disadvantages of such tools are obvious. There is no way to recognize all unknown Ransomware with static methods. Dynamic behavior heuristic detection may recognize more unknown samples than static methods, but it still cannot cover all of them. Meanwhile, since the detection occurs after the ransomware has begun running, at the time an unknown ransomware is flagged, user files may have already been encrypted.

### 2. Mitigation:

AV researchers understood that there was no way to prevent all unknown Ransomware and guarantee to protect all user files. Therefore, mitigation methods are used for recovering the loss of original files. Before files are modified, mitigation tools back up user files and store them in a local or remote system. Therefore, a mitigation tool may be able to recover the original files once it is realized that the original files have been encrypted by Ransomware.

Such a mitigation approach appears good on its face, but in practice still has some problems. For example, the backing up of all files requires constant monitoring of files that are created and/or modified resulting in a heavyweight methodology. Further, the backup files take up large amounts of storage. Meanwhile, if the backup copies are stored on the local host, they may not be safe; and if they are stored on a remote server, the network traffic and privacy become a concern.

There are some tools that attempt to use both pre-prevention and mitigation approaches. Such tools have the advantages and the disadvantage of both approaches.

3. Ransomware Detection with Bait Files:

Some anti-virus software use bait files in an attempt to detect a virus or Ransomware by monitoring whether an unknown program modifies these bait files. There are also some weaknesses for this method. For example, if the ransomware only encrypts particular files or folders, the detection would fail if no bait files are among the particular files or folders impacted. Also, a false negative results if the ransomware recognizes a file as a bait file and avoids encrypting the bait file. Even when the bait files are encrypted and the ransomware is detected as a result, the other useful files might have already been encrypted. As such, this bait file approach usually needs to be coupled with the mitigation method.

In view of the foregoing, there is a need for a lightweight anti-ransomware system that can dynamically detect the running of ransomware and mitigate ransomware without the use of file backups.

### SUMMARY

Systems and methods are described for detecting ransomware. According to one embodiment, a computer device intercepts an operation on a file by an application and determines whether the application is ransomware based on one or more factors. The computer device mitigates the operation to the file when the application is deemed to be ransomware.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a flow diagram illustrating a method for detecting file-encrypting ransomware in accordance with an embodiment of the present invention.

FIG. 2 illustrates an exemplary system registry that can be used for exporting associations of file types and applications in accordance with an embodiment of the present invention.

FIG. 3 illustrates an example of structures of an original file and its encrypted file by ransomware.

FIG. 4 illustrates an example of relative entropies of an original file and a corresponding file encrypted by ransomware.

FIG. 5 illustrates exemplary functional units of an anti-virus engine in accordance with an embodiment of the present invention.

FIG. 6 is an exemplary computer system in which or with which embodiments of the present invention may be utilized.

### DETAILED DESCRIPTION

Systems and methods are described for detecting ransomware. According to one embodiment, a computer device intercepts an operation on a file by an application and determines whether the application represents ransomware based on one or more events. When the application is determined to represent a ransomware program, the computer device mitigates the operation on the file.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The phrase “security device” generally refers to a hardware device or appliance configured to be coupled to a network and to provide one or more of data privacy, protection, encryption and security. The network security device can be a device providing one or more of the following features: network firewalling, VPN, antivirus, intrusion prevention (IPS), content filtering, data leak prevention, antispam, antispyware, logging, reputation-based protections, event correlation, network access control, vulnerability management, application control, load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

Ransomware is one kind of modern malware with different categories. Some of them block the victims' operating systems or screens, but most of them encrypt special files upon arriving at a user machine. According to one embodiment, the anti-virus engine described herein prevents these types of file-encrypting ransomware programs. The file encryption behavior sequences in different Ransomware programs are similar and most of them are combined with several basic actions as illustrated below:

A1. Read data from file;

A2. Encrypt data;

A3. Write data to file;

A4. Delete file;

A5. Rename/Move file A to file B;

The sequences of Ransomware encryption may be:

1. A1, A2, A3, A4;

2. A1, A2, A4, A3;

3. A5, A1, A2, A3;

More . . .

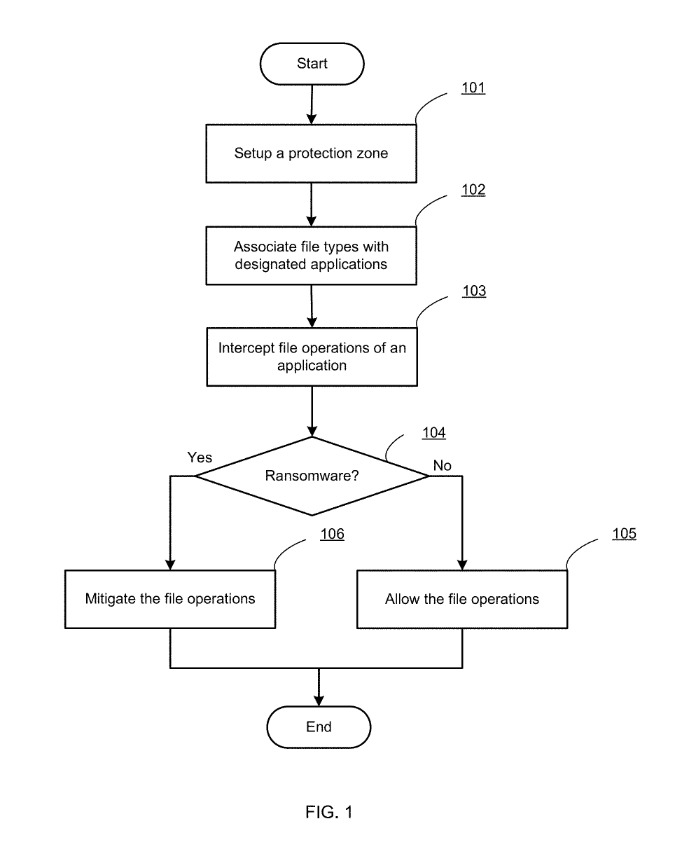

FIG. 1 is a flow diagram illustrating a method for detecting file-encrypting ransomware in accordance with an embodiment of the present invention.

At block 101, an anti-virus engine may optionally setup a protection zone for user files. Operations on the files in the protection zone may be intercepted by the anti-virus engine and prevented from infection by ransomware. For example, files in the protection zone may be backed up to mitigate any malicious encryption of the files. In other example, files in the protection zone may be limited so as to allow them to be operated upon only by designated applications. Operations on the files by other applications will be blocked by the anti-virus engine. A user may designate one or more folders that are used for storing the user's important files as a protection zone. For example, the “My Documents” folder of the WINDOWS (Trademark of Microsoft Corporation) operating system is the default folder for storing user created documents. The anti-virus engine may make this folder a default protection zone for the user. In another example, a user may designate one or more disks/volumes as a protection zone. In a further example, a user may designate target files or particular file types (e.g., those having certain file extensions or those associated with certain applications) that are the most important to him/her. A computer engineer may designate source code files as target files while a photographer may designate picture files as target files. The target files may be treated as a protection zone and protected by the anti-virus engine in the same way.

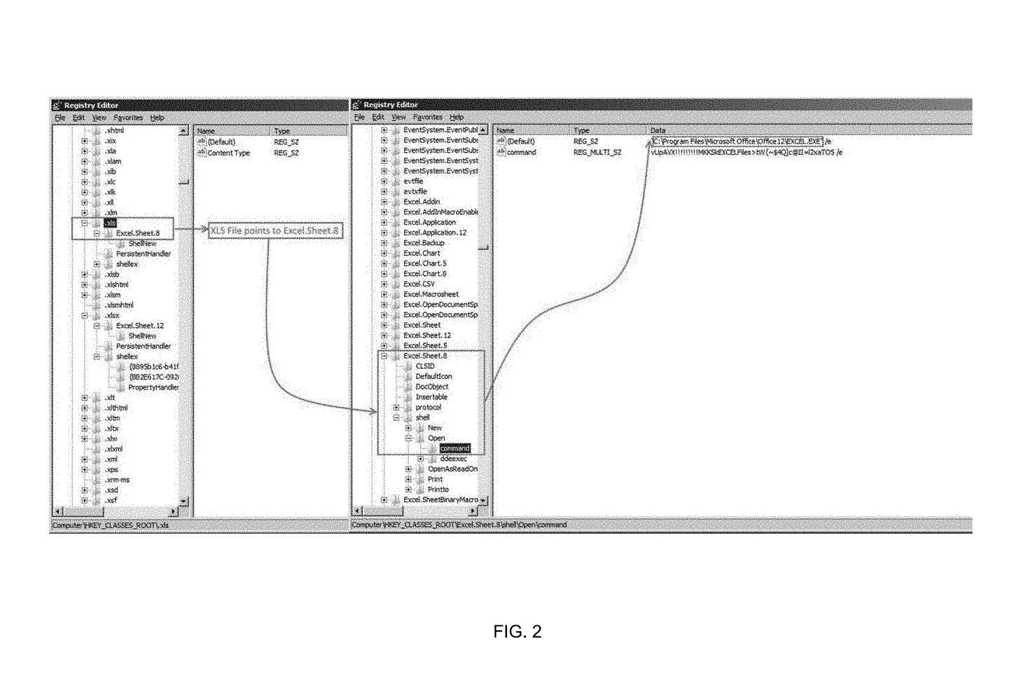

At block 102, the anti-virus engine may associate files or file types with one or more applications that are to be allowed for operating on these files or file types. The operations on these files or files types by non-designated applications will be blocked by the anti-virus engine. FIG. 2 shows an example of a system registry of the WINDOWS operating system that stores associations of file types and corresponding applications. In the system registry of FIG. 2, Excel Sheet file with an extension “.xls” can be opened with the application of “excel.exe” by default. In one embodiment, the anti-virus engine may determine the associations of file types and application by extracting such information from the system registry.

In other example, the anti-virus engine may retrieve the associations of file types and applications from a cloud-based or shared network security appliance. The cloud-based or shared network security appliance may manage a large number of anti-virus applications that are running on client machines/hosts of one or more networks. The network security appliance may collect the associations of file types and applications from these anti-virus applications and share these associations with other anti-virus applications. The network security appliance may further maintain a list of the commonly used applications for the most well-known file types and share the list with anti-virus applications. An example of most commonly used file types and their designated applications may be shown as follow:

.DOC/.DOCX: MS Word, WordPad

.XLS/.XLSX: Excel

.JPG/.PNG/.BMP: MS Paint, Paint.net, Photoshop, GIMP

.DXF: AutoCAD

.TXT: notepad, MS Word, WordPad, . . .

.C: notepad, Visual Studio, . . .

.java: Android Studio . . .

More . . .

In a further example, a user may manually designate one or more applications for a particular file type. Usually, a user may select an application that is not the default application when he/she uses an “open with” command to open the file. The anti-virus engine may save the newly created association within its repository that is used for maintaining associations between legitimate applications for particular files.

At block 103, the anti-virus engine intercepts a file operation of an application. For example, the anti-virus engine may intercept file input/output (I/O) requests using a minifilter driver or other operating system, file system or Application Programming Interface (API) hook. As those skilled in the art will appreciate, the applications that issue the file I/O requests can also be captured by the anti-virus engine.

At block 104, the anti-virus engine determines whether the application that is operating on the file is a ransomware program. In the present example, ransomware is detected based on one or more of the following conditions (as described further below):

1. An application is not a designated application for operating on a file.

2. An application has changed the file format or file structure of a file.

3. An application produces high entropy for a file.

4. An application issues a large amount of file operations.

1. An application is not a designated application for operating on a file.

If the associations of file types and applications are designated as described in block 102, the anti-virus engine may retrieve the file type of the current file and check if the application is one of the designated applications for this file type. For example, when a file I/O request to a “.doc” file issued by an “abc” application is intercepted by the anti-virus engine, the anti-virus engine checks if the “abc” application is in the list of designated applications for “.doc” files. If “abc” application is not one of the designated applications, it may be determined to be a ransomware program.

2. An application has changed the file format or file structure of a file.

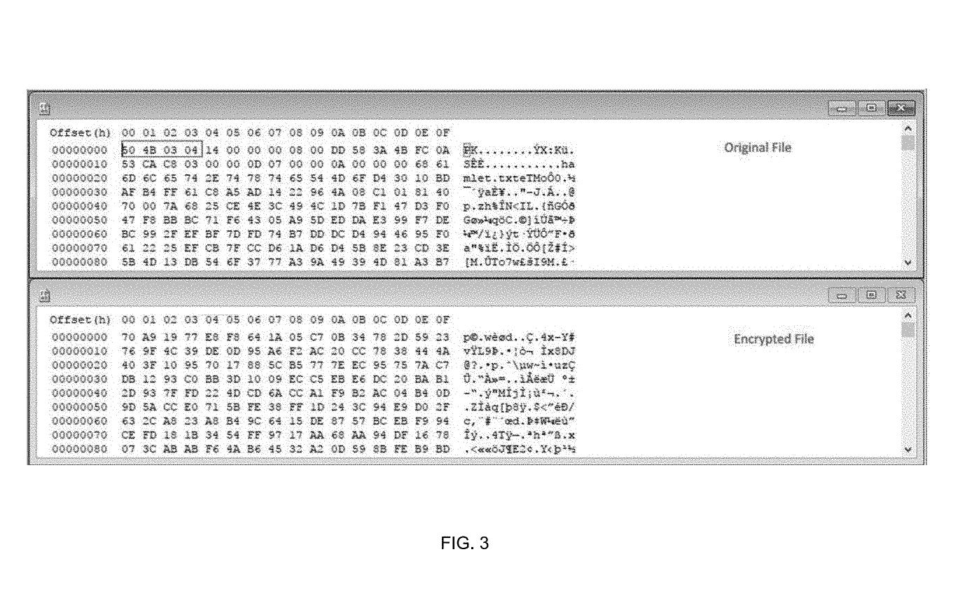

The anti-virus engine may check the file format or file structure of a file when the file is opened by an application and check the file format or structure again after the file is modified. If the file format or file structure is changed, then the anti-virus engine may determine that the application is ransomware. For example, a ZIP file as shown in the upper half of FIG. 3 has a signature “50 4B 03 04” at the beginning of the file. If the file is changed to an encrypted file, the structure/format of the ZIP file, especially the signature at the beginning of the file, is changed as shown in the lower half of FIG. 3. Other commonly used file types, such as doc, pdf, jpg, MP3 and etc., have their own signatures or particular file formats/structures. If the signature/format/structure of a file is changed or damaged by an application, then the anti-virus engine may determine that the application is ransomware or potential ransomware.

3. An application produces high entropy for a file.

Some files do not have a particular structure, for example, a text file may contain pure text in ASCII code without any file signature. In this scenario, the anti-virus engine may calculate an entropy value (V1) for a file before it is operated upon by an application and another entropy value (V2) for the modified version of the file. If the entropy value (V1) is within a normal range for its type (entropy values of normal text files are lower than 5) while the entropy value (V2) of file is higher than a threshold (entropy values of encrypted files are higher than 7), then the anti-virus engine may determine that the application that modified the file is ransomware or potential ransomware. The concept of information entropy was introduced by Claude Shannon in his 1948 paper entitled “A Mathematical Theory of Communication.”

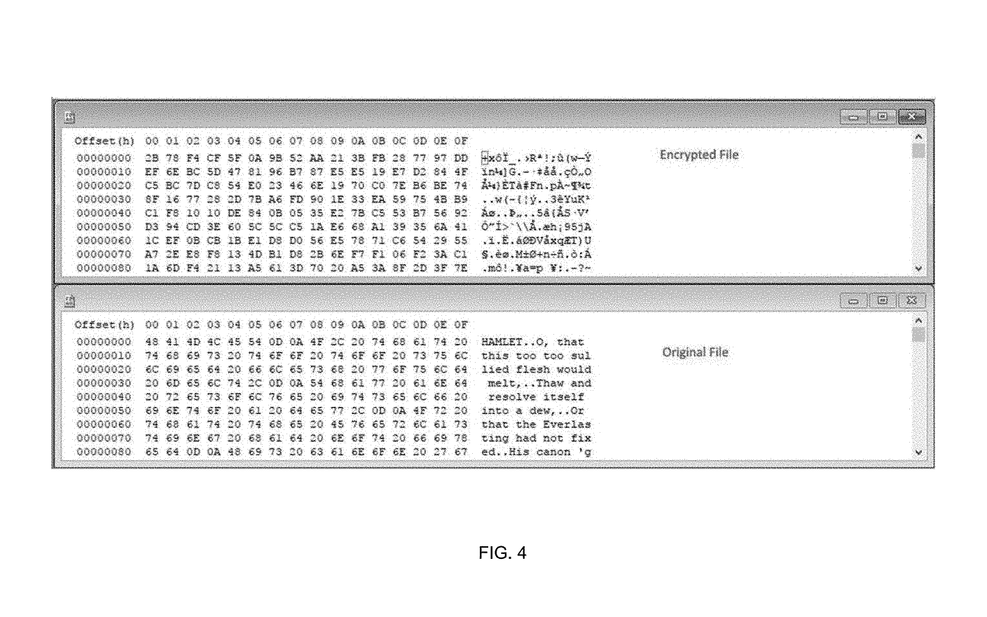

FIG. 4 illustrates an example of an original file and a corresponding encrypted file produced by ransomware. The lower half of FIG. 4 shows a text file with only text contents and the upper half of FIG. 4 shows an encrypted file corresponding to the text file. The entropy of the text file is about 4.6 and the entropy of the encrypted file is about 7.4. It can be seen that the encrypted file is a series chaotic characters which have much higher entropy.

Ransomware may also be detected if an application's modification to a file results in a significant change to a file's entropy. For example, typical revisions to a text file usually modify only a small portion of the file and the file's entropy changes only a little after a normal revision. A sudden increase in entropy, that is the difference between pre- and post-modification entropies (V2-V1) being greater than a predetermined or configurable threshold, may indicate that the file has been encrypted by the application at issue. Thus, the anti-virus engine may determine that the application is ransomware if the application produces or results in a significant change to a file.

4. An application issues a large amount of file operations.

Usually, a normal application only operates on a few files in a particular time period. If the number of file operations, especially writes and deletes, by an application in a particular time period exceeds a predetermined or configurable threshold, the anti-virus engine may determine that the application is a file-encrypting ransomware program. Further, if an application operates/modifies a large number of files while these files are under different folders, it can be a strong indication that this application is ransomware.

When determining if an application is ransomware, the above criteria may be tracked for target files and/or files within the protection zone. For example, operations to the files in protection zone may be limited to the designated applications while files outside of the protection zone may be operated on by any applications. Similarly, the number of file operations may be counted for only the files in the protection zone while operations on other files may be omitted by the anti-virus engine.

When determining if an application is ransomware, the above conditions may be combined or weighted to increase accuracy of the ransomware determination. For example, when only one condition is observed, the application may be deemed as potential ransomware, while after multiple conditions are observed, the application may be determined to be ransomware.

At block 105, if the application is a legitimate application, the intercepted operation issued by the application may be allowed by the anti-virus engine.

At block 106, if the application is determined to be ransomware or is suspected of being ransomware, the anti-virus engine may take an action to mitigate the operation attempting to be performed on the file by the ransomware according to the security policies.

In one example, a file operation performed by an application may be denied directly if the application is not a designated application for this file or file type. Especially, when a file is in a protection zone, operations on the file will be limited to designated applications.

In another example, the anti-virus engine may query the user when a suspect application or an operation on a file is captured. For example, when an application issues too many file operation requests in a short amount of time or the entropies of files become too high after modifications, the anti-virus engine may suspect that the application is ransomware. A warning message may be displayed or sent to the user to allow the user to decide if the application should be allowed to perform the operation at issue. According to one embodiment, the user may be provided with a set of actions from which he/she can choose, such as allow, deny and make a backup copy; and the anti-virus engine will perform the selected option.

In a further example, the anti-virus engine may make a backup copy of a file when a modification request to the file is intercepted. Here, modification includes file write or file deletion. In this manner, should the anti-virus engine fail to detect ransomware and a file is encrypted or deleted by the ransomware, the file may be restored from its backup copy. However, in order to avoid taking up too much storage with backup copies, in one embodiment, a backup copy of a file is made only if the file is in a protection zone or an operation to the file is issued by an application outside of the designated applications. In a situation in which the anti-virus engine detects ransomware or suspect ransomware and issues a warning message to the user that is not active upon by the user, the anti-virus engine may make a backup copy of the file at issue in order to mitigate damage resulting from deletion or encryption of the file at issue.

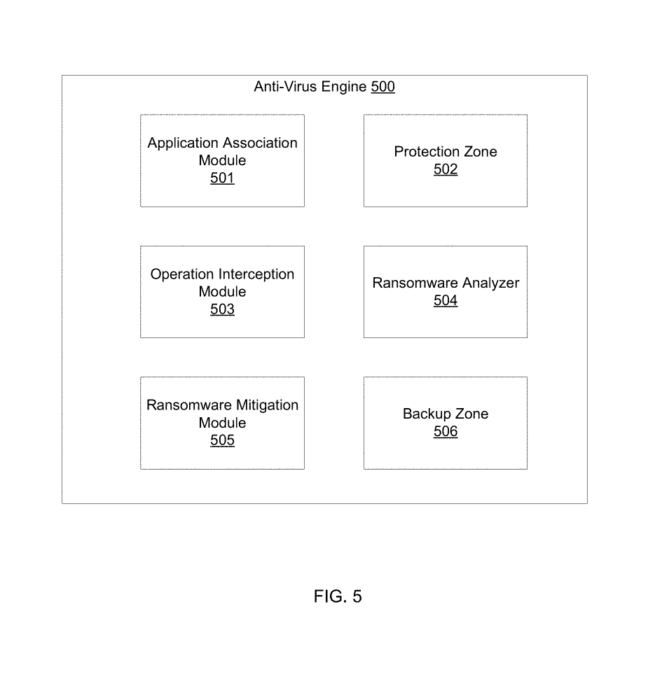

FIG. 5 illustrates exemplary functional units of an anti-virus engine 500 in accordance with an embodiment of the present invention. In this example, anti-virus engine 500 may be a module of a client security application, such as the FORTICLIENT endpoint security application available from the assignee of the present invention (FORTICLIENT is a trademark or a registered trademark of Fortinet, Inc.). Anti-virus engine 500 comprises a file association module 501, a file protection zone 502, an operation interception module 503, a ransomware analyzer 504, a ransomware mitigation module 505 and a backup zone 506.

File association module 501 is used for linking or associating files or file types with designated applications. Operations on files or file types by the designated applications will be allowed while other applications may be deemed to be ransomware. File association module 501 may retrieve the associations between file types and corresponding applications from a system registry of an operating system. Alternatively or additionally, a user may manually designate an application as a legitimate application for a file or file type. The manually designated association may be maintained by file association module 501.

In another example, a network security appliance, such as a FORTIMANAGER centralized device manager or FORTICLOUD cloud-based Software as a Service (Saas) available from the assignee of the present invention, may manage a large number of client security applications across a private network or the Internet (FORTIMANAGER and FORTICLOUD are trademarks or registered trademarks of Fortinet, Inc.). The network security appliance may collect well-known file types and the applications that are used by most users for these well-known file types. The network security appliance may verify whether the applications are safe for the file types and maintain a list or database of the well-known associations. File association module 501 may download the well-known associations from the network security appliance.

Protection zone 502 is used for storing important files of a user. A user may designate one or more folders, disks and/or partitions as being part of protection zone 502. A user may also mark particular files or file types as target files that can be treated as part of protection zone 502. Operations on files in protection zone 502 will be monitored and checked for being originated by ransomware by ransomware analyzer 504.

Operation interception module 503 is used for intercepting file operation requests issued by applications in order to allow the requests and/or applications to be processed and verified before the requests are executed. The interception may be implemented through a minifilter driver or by otherwise hooking the operating system and/or file system API calls desired to be monitored.

Ransomware analyzer 504 is used for analyzing whether a file operation, especially file write and file delete, is allowable and if an application is ransomware. An event or a combination of events may be used for determining whether an application is ransomware. These events may include, but are not limited to, a non-designated application operating on a file or a file type, an application performing too many file operations in a short amount of time, an application accessing a large number of folders in a short amount of time, file structure or file type being changed by an application and/or an entropy value increase as a result of an operation performed on a file by an application.

Ransomware mitigation module 505 is used for mitigating file operations of applications for files in the protected zone or by applications deemed to be ransomware or suspected to be ransomware by ransomware analyzer 504. Ransomware mitigation module 505 may make a backup copy of a file before an application is allowed to operate on the file. Ransomware mitigation module 505 may deny an operation attempted to be performed by an application or query a user for instruction if the application is suspected of being or deemed to be ransomware by ransomware analyzer 504.

Backup zone 506 is used for storing backup copies of files that are to be protected by anti-virus engine 500. Backup zone 506 may be used only for files in protection zone 502 or files suspected of being under a ransomware attack in order to make anti-virus engine 500 lightweight. Backup zone 506 may be located on a local or remote host or a cloud-based drive.

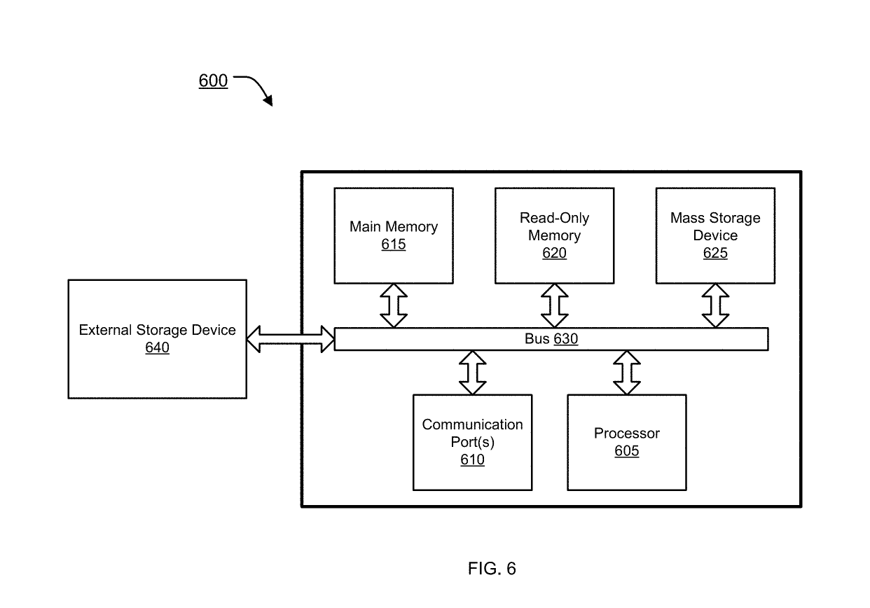

FIG. 6 is an example of a computer system 600 with which embodiments of the present disclosure may be utilized. Computer system 600 may represent or form a part of a network appliance, a server or a client workstation on which an anti-virus engine (e.g., anti-virus engine 500) is running.

Embodiments of the present disclosure include various steps, which have been described in detail above. A variety of these steps may be performed by hardware components or may be embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 600 includes a bus 630, a processor 605, communication port 610, a main memory 615, a removable storage media 640, a read only memory 620 and a mass storage 625. A person skilled in the art will appreciate that computer system 600 may include more than one processor and communication ports.

Examples of processor 605 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 605 may include various modules associated with embodiments of the present invention.

Communication port 610 can be any of an RS-232 port for use with a modem based dialup connection, a 10/100 Ethernet port, a Gigabit or 10 Gigabit port using copper or fiber, a serial port, a parallel port, or other existing or future ports. Communication port 610 may be chosen depending on a network, such a Local Area Network (LAN), Wide Area Network (WAN), or any network to which computer system 600 connects.

Memory 615 can be Random Access Memory (RAM), or any other dynamic storage device commonly known in the art. Read only memory 620 can be any static storage device(s) such as, but not limited to, a Programmable Read Only Memory (PROM) chips for storing static information such as start-up or BIOS instructions for processor 605.

Mass storage 625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 630 communicatively couples processor(s) 605 with the other memory, storage and communication blocks. Bus 630 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 605 to system memory.

Optionally, operator and administrative interfaces, such as a display, keyboard, and a cursor control device, may also be coupled to bus 630 to support direct operator interaction with computer system 600. Other operator and administrative interfaces can be provided through network connections connected through communication port 610.

Removable storage media 640 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
intercepting, by an anti-virus engine running on a computer system, an operation attempting to be performed on a file by an application;
determining, by the anti-virus engine, whether the application is ransomware based on one or more factors, including:
whether the application is a designated application for the file or a type of the file; and
whether a number of file operations performed by the application in a predetermined time period exceeds a predetermined or configurable operation count threshold; and
when a result of said determining is affirmative, then mitigating, by the anti-virus engine, potential adverse consequences of the operation on the file.

2. The method of claim 1, wherein the file is a target file expressly designated as a file or a type of file to be protected by the anti-virus engine.

3. The method of claim 2, wherein the target file is associated with a protection zone that is monitored by the anti-virus engine.

4. The method of claim 3, wherein the protection zone includes one or more of:
one or more files designated by a user of the computer system;
one or more file types designated by the user;
one or more folders of a file system of the computer system designated by the user; and
one or more disks accessible by the computer system designated by the user.

5. The method of claim 1, wherein the operation comprises a write operation or a delete operation.

6. The method of claim 1, wherein the number of file operations is counted for files residing in different folders of a file system of the computer system.

7. The method of claim 1, wherein said determining, by the anti-virus engine, whether the application is ransomware further comprises:
analyzing a file type, a file structure or an entropy of the file before the file is modified by the application;
analyzing the file type, the file structure or the entropy of the file after the file is modified by the application; and
concluding the application is ransomware when one or more of (i) the file type or the file structure is changed and (ii) the entropy of the file is increased beyond a predetermined or configurable entropy threshold as a result of the operation.

8. The method of claim 1, wherein said mitigating, by the anti-virus engine, potential adverse consequences of the operation to the file comprises one or more of:
denying the operation without input from a user of the computer system;
querying the user for input regarding whether the operation should be allowed to proceed; and
making a backup copy of the file before allowing the operation to proceed.

9. The method of claim 1, further comprising:
associating, by the anti-virus engine, a file type with one or more designated applications;
determining, by the anti-virus engine, whether the intercepted operation was issued by a set of one or more designated applications that are associated with the file type of the file;
denying, by the anti-virus engine, performance of the operation by the application when the application is not in the set of one or more designated applications; and
allowing, by the anti-virus engine, performance of the operation by the application when the application is in the set of one or more designated applications.

10. The method of claim 9, wherein said associating, by the anti-virus engine, a file with one or more designated applications further comprises checking a system registry of an operating system of the computer system to determine the one or more designated applications for the file type of the file.

11. The method of claim 9, wherein said associating, by the anti-virus engine, a file with one or more designated applications further comprises retrieving the one or more designated applications for a file type from a cloud-based or shared network security appliance.

12. The method of claim 9, wherein said associating, by the anti-virus engine, a file with one or more designated applications further comprises associating an application with a file type based on a manual association of the file type with the application by a user of the computer system.

13. A computer system comprising:
a non-transitory storage device having embodied therein one or more routines representing a client security application; and
one or more processors coupled to the non-transitory storage device and operable to execute the client security manager to perform a method comprising:
intercepting an operation attempting to be performed on a file by an application;
determining whether the application is ransomware based on one or more factors, including:
whether the application is a designated application for the file or a type of the file; and
whether a number of file operations performed by the application in a predetermined time period exceeds a predetermined or configurable operation count threshold; and
when a result of said determining is affirmative, then mitigating potential adverse consequences of the operation on the file.

14. The computer system of claim 13, wherein the file is a target file expressly designated as a file or a type of file to be protected by the anti-virus engine.

15. The computer system of claim 14, wherein the target file is associated with a protection zone that is monitored by the client security application.

16. The computer system of claim 15, wherein the protection zone includes one or more of:
one or more files designated by a user of the computer system;
one or more file types designated by the user;
one or more folders of a file system of the computer system designated by the user; and
one or more disks accessible by the computer system designated by the user.

17. The computer system of claim 13, wherein the operation comprises a write operation or a delete operation.

18. The computer system of claim 13, wherein the number of file operations is counted for files residing in different folders of a file system of the computer system.

19. The computer system of claim 13, wherein said determining whether the application is ransomware further comprises:
analyzing a file type, a file structure or an entropy of the file before the file is modified by the application;
analyzing the file type, the file structure or the entropy of the file after the file is modified by the application; and
concluding the application is ransomware when one or more of (i) the file type or the file structure is changed and (ii) the entropy of the file is increased beyond a predetermined or configurable entropy threshold as a result of the operation.

20. The computer system of claim 13, wherein said mitigating potential adverse consequences of the operation to the file comprises one or more of:
denying the operation without input from a user of the computer system;
querying the user for input regarding whether the operation should be allowed to proceed; and
making a backup copy of the file before allowing the operation to proceed.

21. The computer system of claim 13, further comprising:
associating a file type with one or more designated applications;
determining whether the intercepted operation was issued by a set of one or more designated applications that are associated with the file type of the file;
denying performance of the operation by the application when the application is not in the set of one or more designated applications; and
allowing performance of the operation by the application when the application is in the set of one or more designated applications.

22. The computer system of claim 21, wherein said associating a file with one or more designated applications further comprises checking a system registry of an operating system of the computer system to determine the one or more designated applications for the file type of the file.

23. The computer system of claim 21, wherein said associating a file with one or more designated applications further comprises retrieving the one or more designated applications for a file type from a cloud-based or shared network security appliance.

24. The computer system of claim 21, wherein said associating a file with one or more designated applications further comprises associating an application with a file type based on a manual association of the file type with the application by a user of the computer system.
